(19) United States
(12) Patent Application Publication
(10) Pub. No.: US 2009/0173637 A1
(43) Pub. Date: Jul. 9, 2009

(54) Manufacture of Multi-Leaf Collimators

(75) Inventor: Duncan Neil Bourne, Redhill (GB)

Correspondence Address: LAHIVE & COCKFIELD, LLP;FLOOR 30, SUITE 3000, ONE POST OFFICE SQUARE, BOSTON, MA, 02109, US

(73) Assignee: Elekta AB (publ), Stockholm (SE)

(21) Appl. No.: 11/988,133

(22) PCT Filed: Jun. 30, 2006
(86) PCT No.: PCT/GB2006/002451

§ 371 Date: Feb. 12, 2009

(30) Foreign Application Priority Data
Jul. 1, 2005 (GB) 0513465.5

(51) Int. Cl. B23H 3/00; G21K 1/02

(52) U.S. Cl. 205/674; 378/147; 205/640; 204/297.01

(57) ABSTRACT

We propose to shape the leaf by the use of electro-chemical machining (ECM). ECM is a technique by which a blank is suspended within a mould, with a small gap therebetween. A conductive fluid is caused to flow through the gap, and a large electrical current is passed from the mould to the blank. The blank steadily erodes, dissolving into the fluid. The fluid should not provoke a reaction from the material of the blank, such as a surface oxide. Sodium Chloride solution is a common choice. The current that is passed can, if desired, be controlled to a profile that will affect the manner of erosion. Thus, the current profile can be a steady on/off current, or it can be pulsed. One known arrangement is for the current to rise to a peak, then fall to zero, followed by a brief reverse flow.

### FIELD OF THE INVENTION

The present invention relates to the manufacture of multi-leaf collimators.

### BACKGROUND ART

Multi-leaf collimators (MLCs) are used (principally) in the field of radiotherapy. A beam of radiation is directed toward a patient and must be collimated to fit the shape of the area to be treated. It is important to ensure that the dose in the areas outside that shape is as low as possible, but also that the whole area is treated. If areas are left untreated then the likelihood of recurrence is increased, whereas if non-treatment regions are irradiated then damage will be caused to healthy tissue resulting in greater side effects and longer recovery times after treatment.

As the treatment area is rarely rectilinear, multi-leaf collimators are employed. These comprise an array of finger-shaped tungsten leaves, each disposed in a parallel relationship and each able to move longitudinally relative to the others. By moving each leaf to a selected position, a collimator is provided with a non-linear edge. In general, one such array (or “bank”) will be provided on each side of the beam.

An example of an MLC is shown in EP-A-0314214.

The leaves must be made to a precise shape—some parts of the leaf shape are dictated by the need to present a clean edge to the x-ray shadow that they create, whereas the shape of other parts is dictated by the needs of the drive and guide mechanisms. High dimensional accuracy is called for in order to provide high clinical accuracy in the treatment delivery.

The leaf is made of tungsten, chosen for its high opacity to x-radiation. Tungsten is generally difficult to process, and (at present) is typically shaped by electro-discharge machining. In this process, a wire is tracked relative to the intended shape and a high voltage is imposed relative to the leaf. A spark is thus created, which erodes the leaf. By moving the wire, a shape can be built up in the tungsten.

### SUMMARY OF THE INVENTION

We propose to shape the leaf by the use of electrochemical machining (ECM).

ECM is a technique by which a blank is suspended within a mould, with a small gap therebetween. A conductive fluid is caused to flow through the gap, and a large electrical current is passed from the mould to the blank. The blank steadily erodes, dissolving into the fluid. The ions thus released are flushed away by the fluid flow, with the aim of preventing them from plating out onto the mould. In essence, the blank is a sacrificial anode.

The rate of erosion is sensitive to the distance between the mould and the surface of the blank. Thus, the blank quickly takes up a shape corresponding to the interior shape of the mould. The two shapes will not be identical, since there will be a small clearance between the mould and the blank, but careful design of the mould and the total charge that is passed allows control of the final shape of the blank.

Some care needs to be taken in the selection of fluid. This should not provoke a reaction from the material of the blank, such as a surface oxide. Such surface coatings may interfere with the conduction process. Sodium Chloride solution is a common choice.

The current that is passed can, if desired, be controlled to a profile that will affect the manner of erosion. Thus, the current profile can be a steady on/off current, or it can be pulsed. One known arrangement is for the current to rise to a peak, then fall to zero, followed by a brief reverse flow. The brief reverse flow acts to clean the mould of any material that may have been plated onto it and thus preserves the life thereof.

### BRIEF DESCRIPTION OF THE DRAWINGS

An embodiment of the present invention will now be described by way of example, with reference to the accompanying figures in which;

FIGS. 1 and 2 show side and end views respectively of a typical MLC leaf; and

FIG. 3 shows a possible current profile.

### DETAILED DESCRIPTION OF THE EMBODIMENTS

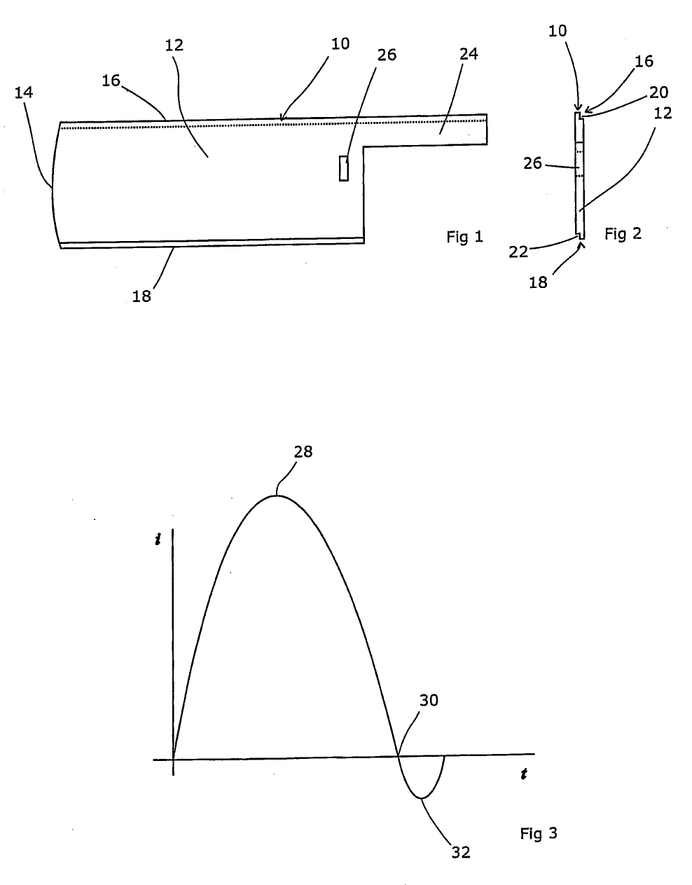

As mentioned above, leaves for multi-leaf collimators have to date been manufactured by spark erosion. Other known techniques have proved to be less suitable due to the properties of the tungsten material from which the leaves need to be made and the relatively complex shape that is required, as shown in FIGS. 1 and 2.

Referring to these figures, the leaf 10 consists generally of a body section 12 whose purpose is to block the x-ray beam into which it is caused to protrude. This needs to be relatively deep in order to cast a sufficiently black shadow. Its width is of course dictated by the resolution of the multi-leaf collimator of which it will form part, and is therefore relatively narrow.

The forward tip 14 of the leaf is rounded so as to present a smooth edge with minimum penumbra regardless of the distance by which the leaf projects into the beam. Given that the x-rays emanate from what can be considered to be a fixed point source, as the leaf is moved further into the beam, the angle at which the beam meets the tip of the leaf will vary. Thus, the tip 14 is rounded so that there is a smooth transition from dark to light regardless of leaf position.

The leaf will, when fitted, slide in grooves formed in a housing. Thus, its upper and lower edges 16, 18 are stepped at 20, 22 to form lips that can slide accurately within the grooves.

The leaf also has a rearwardly projecting lip 24 to assist in alignment, and a through hole 26 that will accept a threaded nut. Thus nut will be threaded onto a rotatable shaft that will be used to drive the leaf 10 forwards and backwards.

The use of spark erosion to form such a shape is however a slow process. It can take up to 24 hours for a single leaf to be manufactured. Thus, to manufacture sufficient leaves it is necessary to maintain a large number of spark erosion machines in parallel.

Electro-chemical machining (ECM) offers the potential for much higher rates of removal; a single leaf could be completed within minutes. It also allows for a smoother surface finish as compared to the pitted effect produced by spark erosion; while suitable selection of spark processes can reduce the pit size, these will generally remain. Hitherto, ECM has only been employed in niche processes such as the manufacture of turbine blades and shaver heads, and does not seem to have found general application.

To form a leaf via ECM will be straightforward in principle. A mould will be needed, with an internal shape that is an enlarged version of the intended leaf shape, thus allowing for the small clearance between the mould and the final leaf shape. The mould will need a connection to an electrical power source, and an inlet and outlet for a conductive fluid. The roughly shaped blank will be placed in the mould and connected to the anode of the electrical power source. The fluid flow is started, and the power source is activated. Material of the blank is deposited into solution in the fluid, and is flushed away by flow of the fluid.

As erosion continues, the distance between the mould and the blank will increase. As the distance increases, the local electrical resistance across the gap will increase. Thus, the process has an inherent negative feedback, and the gap will become more regular automatically, thus ensuring that the final shape of the blank corresponds to the internal shape of the mould.

The current that is passed can, if desired, be controlled to a profile that will affect the manner of erosion. Thus, the current profile can be a steady on/off current, or it can be pulsed. One known arrangement is shown in FIG. 3. The current rises to a peak 28, then falls to zero at 30, followed by a brief reverse flow 32. The brief reverse flow acts to clean the mould of any material that may have been plated onto it and thus preserves the life thereof.

It will of course be understood that many variations may be made to the above-described embodiment without departing from the scope of the present invention.

1. A method of manufacturing a leaf for a multi-leaf collimator comprising employing an electro-chemical machining technique to produce the leaf.

2. A method according to claim 1, further comprising employing Sodium Chloride solution as a conductive working fluid in the electro-chemical machining technique.

3. A method according to claim 1, further comprising passing a substantially constant current during the electro-chemical machining step.

4. A method according to claim 3, further comprising controlling the current that is passed to a non-linear profile.

5. A method according to claim 4, wherein the non-linear profile is one that rises to a peak.

6. A method according to claim 5, further comprising, subsequent to the peak, reversing the current.

7. A leaf for a multi-leaf collimator having a shape imparted to it by a process of electro-chemical machining.

8. A multi-leaf collimator including at least one leaf according to claim 7.

9. A mold for use in electro-chemical machining, comprising a connection for an electrical source, an inlet for a conductive fluid, and an internal shape that corresponds to a desired shape of a multi-leaf collimator.

10. (canceled)

11. (canceled)
